(19) United States
(12) Patent Application Publication
(10) Pub. No.: US 2020/0154441 A1
(43) Pub. Date: May 14, 2020

(54) Interference Mitigation Control

(71) Applicant: Telefonaktiebolaget LM Ericsson (publ), Stockholm (SE)

(72) Inventors: Junying Liu, Lund (SE); Torgny Palenius, Barsebäck (SE); Emma Wittenmark, Lund (SE); Mikael Zirén, Kävlinge (SE)

(21) Appl. No.: 16/610,270

(22) PCT Filed: Jun. 22, 2017
(86) PCT No.: PCT/EP2017/065418

§ 371 Date: Nov. 1, 2019

(51) Int. Cl. H04W 72/08; H04B 17/318; H04W 48/16; H04L 5/14

(52) U.S. Cl. CPC H04W 72/082; H04L 5/14; H04W 48/16; H04B 17/318

(57) ABSTRACT

A method is disclosed for controlling interference mitigation of a wireless communication device operating in a first system provided by a first wireless communication system operator. The first system uses a first frequency interval and a first UL/DL configuration. The method comprises detecting (310) presence of a second system provided by a second wireless communication system operator which is different than the first wireless communication system operator. The second system uses a second frequency interval, which is overlapping with, or neighboring to the first frequency interval. The method also comprises acquiring (320) a second UL/DL configuration used by the second system by detecting wireless control signaling from the second system, and monitoring (330) a received signal strength metric of the second system. The method comprises selecting (340), based on the acquired second configuration and on the monitored received signal strength metric of the second system, an interference mitigation algorithm from a set of applicable interference mitigation algorithms comprising at least a successive interference cancellation algorithm and an interference rejection algorithm. Corresponding arrangement, wireless communication device and computer program product are also disclosed.

### TECHNICAL FIELD

The present disclosure relates generally to the field of wireless communication. More particularly, it relates to interference mitigation in wireless communication systems.

### BACKGROUND

Numerous interference mitigation approaches are available, and the various interference mitigation approaches may have different benefits and/or requirements. For example, there exist algorithms based on successive interference cancellation (SIC) and algorithms based on interference rejection (IR). Examples of interference mitigation approaches are generally well known in the art and will not be lengthily elaborated on herein although a few contextual examples will be mentioned.

An example of a SIC-based algorithm is the network assisted interference cancellation and suppression (NAICS) available in 3GPP (Third Generation Partnership Project) standards related to LTE (Long Term Evolution). The basic principle in NAICS is exchange of semi-static cell configuration information between neighboring base stations (BS:s, e.g. evolved NodeB:s, eNB:s) of the same operator through a backhaul interface, combined with high level signaling from a serving base station to wireless communication devices (e.g. user equipments, UE:s) to convey cell configuration parameters of neighboring cells to the wireless communication devices. The semi-static cell configuration information and cell configuration parameters may comprise physical cell identification (pci), number of Cell Specific Reference Signal (CRS) ports, Multicast-Broadcast Single-Frequency Network (MBSFN) configuration, and used transmission modes. The wireless communication devices can utilize the knowledge of cell configuration parameters to perform cancellation/suppression for interference from the neighboring cells.

In time division duplex (TDD) systems, each time resource (e.g. a sub-frame) is configured as an uplink (UL) resource, a downlink (DL) resource, or a special resource (e.g. a special sub-frame inserted between downlink and uplink sub-frames to avoid overlap of reception and transmission at the wireless communication device).

It is generally possible that different operators deploy wireless communication systems in the same, or overlapping, or neighboring geographical areas while using the same, or overlapping, or neighboring frequency intervals for communication. Such scenarios become even more likely with growing traffic demand and limited spectrum resources.

In these scenarios and when TDD is deployed, different interference scenarios may arise depending on the DL/UL configurations of the different systems. UE-to-UE and/or BS-to-BS interference may be introduced for unsynchronized sub-frames (DL in serving system and UL in interfering system, or vice versa), while BS-to-UE interference may be introduced for synchronized sub-frames (DL in both serving and interfering system) and in FDD (frequency division duplex) deployments. UE-to-UE and/or BS-to-UE interference obviously risk entailing very bad user experience (e.g. out of sync or drop a phone call). Therefore, it is desirable to mitigate interference in these scenarios.

It is typically not possible to apply NAICS to interference situations where there is no exchange of information between serving base station and interfering base station, as is typically the case when the base stations are associated with different operators. Thus, in these situations, interference mitigation needs to be based on other principles, e.g. interference rejection. An example of an IR-based algorithm is interference rejection combining (IRC), where a correlation approach is used to mitigate interference and no specific information from the network is required. However, IR-based algorithms are typically less efficient than SIC-based algorithms and therefore, interference cannot always be efficiently mitigated in situations with different operators.

Therefore, there is a need for alternative interference mitigation approaches for scenarios where different operators deploy systems such that one of the systems causes interference to another one of the systems.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

It is an object of some embodiments to solve or mitigate, alleviate, or eliminate at least some of the above or other disadvantages.

According to a first aspect, this is achieved by a method for controlling interference mitigation for received signals of a wireless communication device operating in a first system, using a first frequency interval. The first system is provided by a first wireless communication system operator.

The method comprises detecting presence of a second system using a second frequency interval, wherein the first and second frequency intervals are overlapping or neighboring frequency intervals. The second system is provided by a second wireless communication system operator which is different than the first wireless communication system operator.

The method also comprises monitoring a received signal strength metric of the second system.

The method comprises selecting, based on the monitored received signal strength metric of the second system, an interference mitigation algorithm from a set of applicable interference mitigation algorithms comprising at least a first interference mitigation algorithm and a second interference mitigation algorithm. The first interference mitigation algorithm is a successive interference cancellation algorithm and the second interference mitigation algorithm is an interference rejection algorithm.

In some embodiments, wherein the first and second frequency intervals are neighboring frequency intervals, detecting the presence of the second system may comprise performing a received signal strength metric scan over one or more third frequency intervals comprising the second frequency interval and determining a maximum received signal strength metric of the scan.

The method may, in some embodiments, comprise comparing the maximum signal strength metric of the scan to a maximum interference threshold value and, when it is determined that the maximum received signal strength metric of the scan is above the maximum interference threshold value, attempting operation in a wireless communication system other than the first system.

According to some embodiments, detecting the presence of the second system may further comprise comparing the maximum received signal strength metric of the scan to a detection threshold value. When it is determined that the maximum received signal strength metric of the scan is above the detection threshold value, cell search may be performed based on a candidate frequency associated with the maximum received signal strength metric of the scan and the presence of the second system may be considered detected when the cell search is successful. The detection threshold value may be based on a received signal strength metric of the first system in some embodiments.

In some embodiments, the first system is a first time division duplex, TDD, system using a first configuration of time resources for downlink and uplink and the second system is a second TDD system. The method may further comprise acquiring, by detecting wireless control signaling from the second TDD system, a second configuration of time resources for downlink and uplink used by the second TDD system, and selecting the interference mitigation algorithm may be further based on the acquired second configuration.

Acquiring the second configuration may comprise reading system information received from the second TDD system according to some embodiments.

In some embodiments, the method may further comprise monitoring a received signal quality metric of the first system. Selecting interference mitigation algorithm may comprise comparing the monitored signal strength metric of the second system to a selection interference threshold value and the monitored received signal quality metric of the first system to a selection quality threshold value.

When it is determined that the monitored signal strength metric of the second system is above the selection interference threshold value and the monitored received signal quality metric of the first system is below the selection quality threshold value, the method may comprise selecting the first interference mitigation algorithm for the received signals of the first system.

When the first system is a first TDD system and the second system is a second TDD system, selecting the first interference mitigation algorithm for the received signals of the first system may be applied as indicated above when a corresponding time resource of the acquired second configuration is a time resource for downlink.

When it is determined that the monitored signal strength metric of the second system is above the selection interference threshold value and the monitored received signal quality metric of the first system is below the selection quality threshold value, the method may comprise selecting the second interference mitigation algorithm for the received signals of the first system.

This approach may be applied when the first system is a first FDD system and the second system is a second FDD system.

Alternatively or additionally, when the first system is a first TDD system and the second system is a second TDD system, selecting the second interference mitigation algorithm for the received signals of the first system may be applied as indicated above when the corresponding time resource of the acquired second configuration is not a time resource for downlink.

According to some embodiments, the method may further comprise monitoring a received signal quality metric of the second system, and selecting interference mitigation algorithm may be further based on the monitored received signal quality metric of the second system.

The method may also, in some embodiments, comprise applying the selected interference mitigation algorithm to the received signals of the first system to reduce the interference caused by the second system.

A second aspect is a computer program product comprising a computer readable medium, having thereon a computer program comprising program instructions. The computer program is loadable into a data processing unit and configured to cause execution of the method according to the first aspect when the computer program is run by the data processing unit.

A third aspect is an arrangement for controlling interference mitigation for received signals of a wireless communication device operating in a first system using a first frequency interval. The first system is provided by a first wireless communication system operator.

The arrangement comprises a controller configured to cause detection of presence of a second system using a second frequency interval, wherein the first and second frequency intervals are overlapping or neighboring frequency intervals. The second system is provided by a second wireless communication system operator which is different than the first wireless communication system operator.

The controller is also configured to cause monitoring of a received signal strength metric of the second system.

The controller is configured to cause selection, based on the monitored received signal strength metric of the second system, of an interference mitigation algorithm from a set of applicable interference mitigation algorithms comprising at least a first interference mitigation algorithm and a second interference mitigation algorithm. The first interference mitigation algorithm is a successive interference cancellation algorithm and the second interference mitigation algorithm is an interference rejection algorithm.

A fourth aspect is a wireless communication device comprising the arrangement of the third aspect.

In some embodiments, any of the above aspects may additionally have features identical with or corresponding to any of the various features as explained above for any of the other aspects.

An advantage of some embodiments is that interference mitigation is provided for scenarios where different operators deploy systems such that one of the systems causes interference to another one of the systems.

Another advantage of some embodiments is that improved downlink reliability and/or robustness may be provided in situations as described above.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a schematic drawing illustrating an example scenario where some embodiments may be applicable;

FIG. 2 is a schematic drawing of example frequency intervals according to some embodiments;

FIG. 3 is a flowchart illustrating example method steps according to some embodiments;

FIG. 4 is a flowchart illustrating example method steps according to some embodiments;

FIG. 5 is a flowchart illustrating example method steps according to some embodiments;

FIG. 6 is a flowchart illustrating example method steps according to some embodiments;

FIG. 7 is a schematic block diagram illustrating an example arrangement according to some embodiments; and

FIG. 8 is a schematic drawing illustrating an example computer readable medium according to some embodiments.

### DETAILED DESCRIPTION

Embodiments of the present disclosure will be described and exemplified more fully hereinafter with reference to the accompanying drawings. The solutions disclosed herein can, however, be realized in many different forms and should not be construed as being limited to the embodiments set forth herein.

Embodiments will be described herein using TDD systems as an example, wherein the embodiments may be described in the text and/or may be illustrated by the drawings. However, it should be understood that some embodiments may be equally applicable to scenarios where the first system and/or the second system is not a TDD system (e.g. a frequency division duplex, FDD, system).

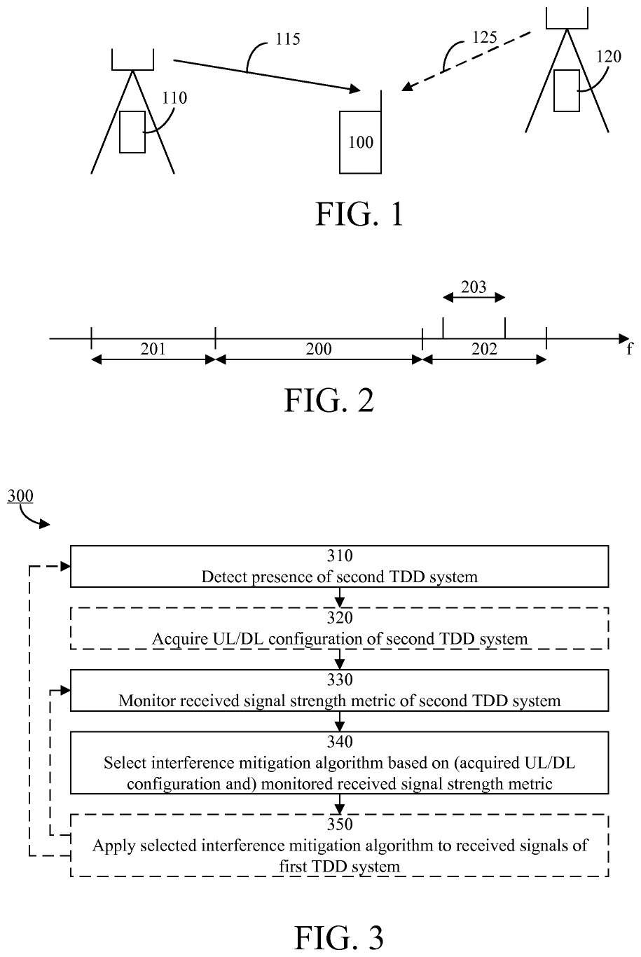

In the following, embodiments will be described where interference mitigation is provided for scenarios where different operators deploy TDD systems such that one of the TDD systems causes interference to another one of the TDD systems. FIG. 1 is a schematic drawing illustrating an example of such a scenario, where a wireless communication device (e.g. a UE) 100 receives DL TDD communication 115 from a serving base station 110 and concurrently is interfered by DL TDD transmissions 125 from another base station 120.

The serving base station 110 may be part of a first TDD system provided by a first wireless communication system operator. The other base station 120 may be part of a second TDD system provided by a second wireless communication system operator which is different than the first wireless communication system operator.

The serving base station 110 may use a first frequency interval and a first configuration of time resources (e.g. sub-frames) for downlink and uplink (UL/DL configuration). The other base station 120 may use a second frequency interval and a second configuration of time resources for downlink and uplink.

FIG. 2 schematically illustrates an example first frequency interval 200. Generally, the first and second frequency intervals may be overlapping or neighboring (e.g. adjacent) frequency intervals. In FIG. 2 an example second frequency interval is illustrated by the neighboring frequency interval 203. Two examples of third frequency intervals 201, 202 are also illustrated, over which a received signal strength metric scan may be performed as will be elaborated on later herein.

FIG. 3 illustrates an example method 300 according to some embodiments. The example method 300 is a method for controlling interference mitigation of a wireless communication device (compare with the wireless communication device 100 of FIG. 1) operating in a first TDD system provided by a first wireless communication system operator (compare with the system associated with the base station 110 of FIG. 1) and potentially being interfered by a second TDD system provided by a second wireless communication system operator which is different than the first wireless communication system operator (compare with the system associated with the base station 120 of FIG. 1).

The first TDD system uses a first frequency interval (compare with 200 of FIG. 2) and a first configuration of time resources for downlink and uplink (UL/DL configuration) and the second TDD system uses a second frequency interval (compare with 203 of FIG. 2) and a second configuration of time resources for downlink and uplink. The first and second frequency intervals may be overlapping or neighboring (e.g. adjacent) frequency intervals.

In step 310 of the example method 300, the wireless communication device detects presence of the second TDD system.

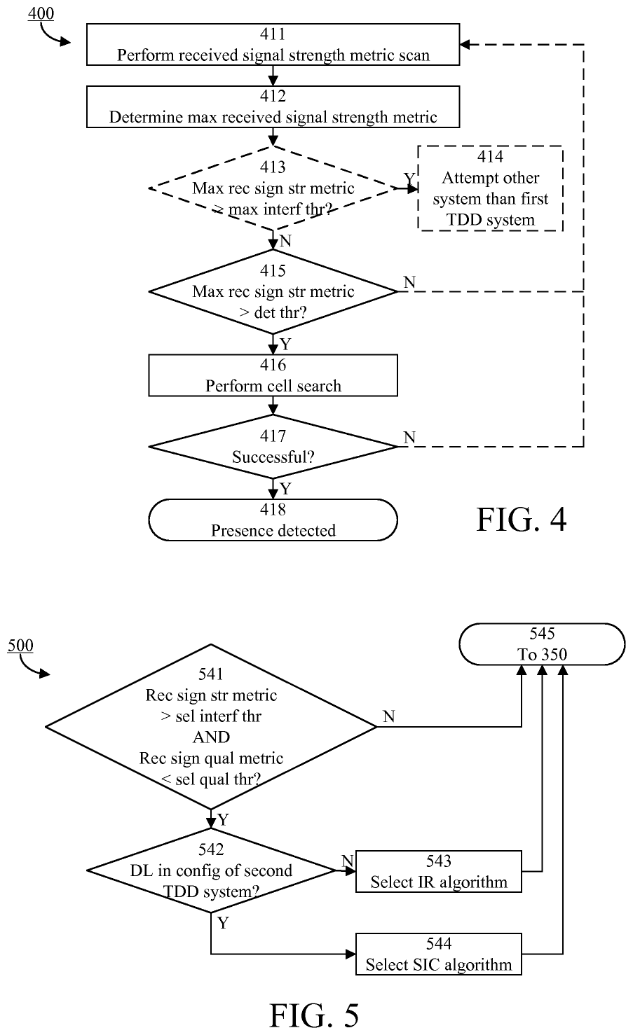

FIG. 4 illustrates an example method 400 for detecting presence of a second TDD system. The example method 400 may be performed in step 310 of the example method 300 illustrated in FIG. 3. The example method 400 is particularly relevant when the first and second frequency intervals are neighboring frequency intervals (compare with 200 and 203 of FIG. 2).

In step 411, the wireless communication device performs a received signal strength metric (e.g. RSSI, Received Signal Strength Indicator) scan over one or more third frequency intervals. The one or more third frequency intervals may typically be adjacent to the first frequency interval (compare with 201 and 202 of FIG. 2). If the second frequency interval is comprised in one of the one or more third frequency intervals, the signaling of the second TDD system will manifest itself in the scanned received signal strength metric (provided the signals of the second TDD system is strong enough).

A maximum received signal strength metric of the scan is determined in step 412. Such maximum received signal strength metric may indicate the presence of a possible second TDD system.

In some embodiments, the maximum signal strength metric of the scan is compared to a maximum interference threshold value as illustrated in optional step 413. If the maximum received signal strength metric of the scan is above the maximum interference threshold value (Y-path out from step 413), it may be considered that the interference is too strong for successful mitigation and operation in a wireless communication system other than the first TDD system may be attempted instead as illustrated by optional step 414. The maximum interference threshold value may be static or dynamically set in relation to a received signal strength metric of the first TDD system.

If the maximum received signal strength metric of the scan is not above the maximum interference threshold value (N-path out from step 413), or if optional step 413 is not applied, the wireless communication device compares the maximum received signal strength metric of the scan to a detection threshold value in step 415. The detection threshold value may be static or dynamically set in relation to a received signal strength metric of the first TDD system.

If the maximum received signal strength metric of the scan is not above the detection threshold value (N-path out from step 415), it may be considered that the interference is not particularly strong and that no further effort should be made to detect whether the maximum received signal strength metric is caused by presence of a second TDD system. Either, interference may be mitigated using the second interference mitigation algorithm or no interference mitigation may be applied at all. The method may return to step 411 where a new received signal strength metric scan may be performed as suitable (e.g. periodically or based on some suitable criterion).

If the maximum received signal strength metric of the scan is above the detection threshold value (Y-path out of step 415), the wireless communication device may perform cell search based on a candidate frequency associated with the maximum received signal strength metric of the scan as illustrated by step 416.

If the cell search is successful (e.g. if a cell identity is found of a TDD system; Y-path out from step 417), presence of the second TDD system is considered detected as illustrated by step 418. If the cell search is not successful (N-path out from step 417), the method may return to step 411 where a new received signal strength metric scan may be performed as suitable (e.g. periodically or based on some suitable criterion).

When the first and second frequency intervals are overlapping frequency intervals, an approach similar to that of FIG. 4 may be applied to detect the second TDD systems via parts of the second frequency interval falling outside the first frequency interval.

Alternatively or additionally, a scan over the first frequency interval may be performed to identify a frequency with a minimal signal-to-interference ratio (SIR) for the first TDD system, corresponding to a maximum signal strength metric of the second TDD system (compare with steps 411 and 412).

In some embodiments, the minimal signal-to-interference ratio of the scan is compared to a minimal signal-to-interference ratio threshold value (compare with step 413). If the minimal signal-to-interference ratio of the scan is below the minimal signal-to-interference ratio threshold value, it may be considered that the interference is too strong for successful mitigation and operation in a wireless communication system other than the first TDD system may be attempted instead (compare with step 414).

If the minimal signal-to-interference ratio of the scan is not below the minimal signal-to-interference ratio, or if comparison to the minimal signal-to-interference ratio threshold value is not applied, the wireless communication device compares the minimal signal-to-interference ratio of the scan to a detection SIR threshold value (compare with step 415).

If the minimal signal-to-interference ratio of the scan is not below the detection SIR threshold value, it may be considered that the interference is not particularly strong and that no further effort should be made to detect whether the minimal signal-to-interference ratio is caused by presence of a second TDD system. Either, interference may be mitigated using the second interference mitigation algorithm or no interference mitigation may be applied at all.

If the minimal signal-to-interference ratio of the scan is below the detection threshold value, the wireless communication device may perform cell search based on a candidate frequency associated with the minimal signal-to-interference ratio of the scan (compare with step 416).

If the cell search is successful (e.g. if a cell identity is found of a TDD system), presence of the second TDD system is considered detected (compare with steps 417 and 418).

If the cell search is not successful, or if the minimal signal-to-interference ratio of the scan is not below the detection SIR threshold value, the method may return to a step where a new scan may be performed as suitable (e.g. periodically or based on some suitable criterion).

Returning to FIG. 3, the example method 300 proceeds to step 320 when presence of a second TDD system is detected. In step 320, the second configuration of time resources for downlink and uplink is acquired by detecting wireless control signaling from the second TDD system. Thus, the wireless communication device acquires the second configuration without any assistance or signaling from its serving network node (compare with the base station 110 of FIG. 1). Acquiring the second configuration may comprise reading system information (e.g. System Information Block 1, SIB1) received from the second TDD system.

Carrying on, the wireless communication device monitors a received signal strength metric (e.g. received signal strength indicator, RSSI) of the second TDD system in step 330.

In step 340, the wireless communication device selects an interference mitigation algorithm based on the acquired second configuration and on the monitored received signal strength metric of the second TDD system. The interference mitigation algorithm is selected from a set of applicable interference mitigation algorithms comprising at least a first interference mitigation algorithm and a second interference mitigation algorithm. The first interference mitigation algorithm is a successive interference cancellation algorithm (e.g. similar to NAICS) and the second interference mitigation algorithm is an interference rejection algorithm (e.g. IRC).

FIG. 5 illustrates an example method 500 for selecting the interference mitigation algorithm. The example method 500 may be performed in step 340 of the example method 300 illustrated in FIG. 3. When the example method 500 is applied, a received signal quality metric (e.g. a SINR or a reference signal received quality, RSRQ) of the first TDD system is monitored in addition to the received signal strength metric of the second TDD system. As indicated before, the received signal quality metric of the first TDD system may be seen as a function of the received signal strength metric of the second TDD system.

In the example illustrated in FIG. 5, selecting interference mitigation algorithm comprises comparing the monitored signal strength metric of the second TDD system to a selection interference threshold value and the monitored received signal quality metric of the first TDD system to a selection quality threshold value as illustrated in step 541. Typically, the previously mentioned detection threshold value is lower the selection threshold value, which in turn is lower than the maximum interference threshold value.

If the monitored signal strength metric of the second TDD system is not above the selection interference threshold value or the monitored received signal quality metric of the first TDD system is not below the selection quality threshold value (N-path out from step 541), it may be considered that the interference is not particularly strong. When proceeding to step 350 of FIG. 3, as indicated by step 545, at least two possibilities may be envisioned. Either, interference may be mitigated using the second interference mitigation algorithm or no interference mitigation may be applied at all.

If the monitored signal strength metric of the second TDD system is above the selection interference threshold value and the monitored received signal quality metric of the first TDD system is below the selection quality threshold value (Y-path out from step 541), the example method 500 checks whether a corresponding time resource of the acquired second configuration is a time resource for downlink, as illustrated by step 542. In some embodiments, a corresponding time resource is considered as any time resource that at least partly overlap with a time resource of the received signal of the first TDD system in which interference mitigation is to be applied.

If so (Y-path out from step 542), it is possible to use a SIC-based algorithm and the method comprises selecting such an interference mitigation algorithm for the received signals of the first TDD system as illustrated in step 544. Typically, the wireless communication device may evaluate whether the interferer is dominant (e.g. by evaluating a received signal quality of the second TDD system), and still not use a SIC-based algorithm if the interferer is not dominant.

If not (N-path out from step 542), the method may comprise selecting a non-SIC-based interference mitigation algorithm for the received signals of the first TDD system as illustrated by the selection of an IR-based algorithm in step 543. Alternatively, no interference mitigation at all may be applied in this case. Yet alternatively, a SIC-based algorithm may be applied also in this case.

Regardless of which interference mitigation algorithm is chosen in either of steps 543 and 544, the method proceeds to step 350 of FIG. 3 as indicated by step 545. There, the selected interference mitigation algorithm may be applied to received signals of the first TDD system as suitable to reduce the interference caused by the second TDD system, which is illustrated by optional step 350 in FIG. 3.

As illustrated by the optional looping arrows in FIG. 3, the example method may return to step 310 (e.g. periodically or based on some suitable criterion) to re-evaluate the detection of presence of a second TDD system and/or may return to step 330 (e.g. periodically or based on some suitable criterion) to continue the monitoring of the received signal strength metric of the second TDD system.

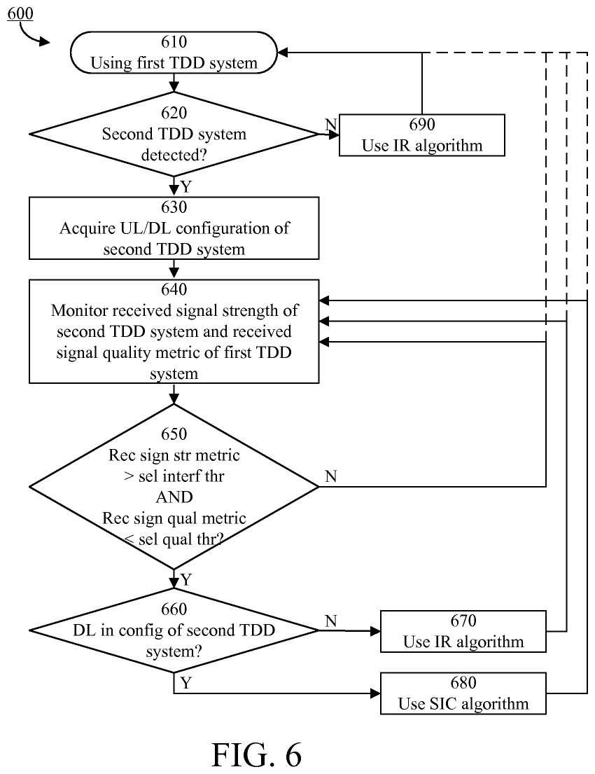

FIG. 6 illustrates an example method 600 according to some embodiments. The example method 600 may be seen as an alternative to, or another way to describe, the method described above in connection to FIGS. 3-5.

As above, the method 600 is for controlling interference mitigation of a wireless communication device (compare with the wireless communication device 100 of FIG. 1) operating in a first TDD system as indicated by step 610. The first TDD system is provided by a first wireless communication system operator and the wireless communication device is potentially interfered by a second TDD system provided by a second wireless communication system operator which is different than the first wireless communication system operator. Other particulars of the first and second TDD systems may correspond to those described in connection with FIGS. 3-5.

In step 620 (compare with step 310 of FIG. 3), the wireless communication device determines whether presence of the second TDD system is detected. If not (N-path out from step 620) an IR-based interference mitigation algorithm may be used as indicated by step 690, and the method may iterate steps 610 and 620 as suitable.

When presence of a second TDD system is detected (Y-path out from step 620), the method proceeds to step 630, where the second configuration of time resources for downlink and uplink is acquired (compare with step 320 of FIG. 3).

The wireless communication device monitors a received signal strength metric of the second TDD system and a received signal quality metric of the first TDD system in step 640 (compare with step 330 of FIG. 3).

In step 650, the monitored signal strength metric of the second TDD system is compared to a selection interference threshold value and the monitored received signal quality metric of the first TDD system is compared to a selection quality threshold value (compare with steps 340 and 541 of FIGS. 3 and 5, respectively).

If the monitored signal strength metric of the second TDD system is not above the selection interference threshold value or the monitored received signal quality metric of the first TDD system is not below the selection quality threshold value (N-path out from step 650), it may be considered that the interference is not particularly strong and the method may return to step 640 or to step 610 as applicable.

If the monitored signal strength metric of the second TDD system is above the selection interference threshold value and the monitored received signal quality metric of the first TDD system is below the selection quality threshold value (Y-path out from step 650), the example method 600 checks whether a corresponding time resource of the acquired second configuration is a time resource for downlink, as illustrated by step 660 (compare with step 542 of FIG. 5).

If so (Y-path out from step 660), the method comprises selecting and using a SIC-based interference mitigation algorithm for the received signals of the first TDD system as illustrated in step 680 (compare with step 544 of FIG. 5).

If not (N-path out from step 660), the method comprise selecting and using an IR-based interference mitigation algorithm for the received signals of the first TDD system as illustrated in step 670 (compare with step 543 of FIG. 5).

Regardless of which interference mitigation algorithm is chosen in either of steps 670 and 680, the method may return to step 640 or to step 610 as applicable.

Any of the methods described above may, in some embodiments, further comprise monitoring a received signal quality metric of the second TDD system, and selecting the interference mitigation algorithm further based on the monitored received signal quality metric of the second TDD system.

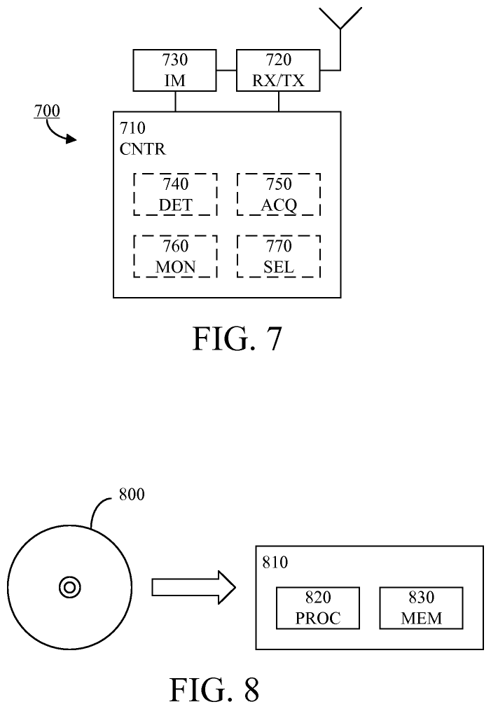

FIG. 7 schematically illustrates an example arrangement 700 according to some embodiments. The example arrangement 700 may, for example, be comprised in a wireless communication device (compare with the wireless communication device 100 of FIG. 1) and/or may be adapted to perform any of the method steps as described in connection with FIGS. 3-6.

The example arrangement 700 is for controlling interference mitigation of a wireless communication device operating in a first TDD system provided by a first wireless communication system operator and potentially being interfered by a second TDD system provided by a second wireless communication system operator which is different than the first wireless communication system operator. The first TDD system uses a first frequency interval and a first configuration of time resources for downlink and uplink and the second TDD system uses a second frequency interval and a second configuration of time resources for downlink and uplink. The first and second frequency intervals may be overlapping or neighboring frequency intervals.

The arrangement comprises a controller (CNTR) 710, and may optionally comprise or be connectable to a transceiver (RX/TX, e.g. transceiving circuitry) 720 and an interference mitigator (IM, e.g. interference mitigating circuitry) 730.

The controller 710 is configured to cause the method steps as described in connection with FIG. 3. To this end the controller may comprise or be connectable to a detector (DET, e.g. detecting circuitry) 740, an acquirer (ACQ, e.g. acquiring circuitry) 750, a monito (e.g. monitoring circuitry) 760 and a selector (SEL, e.g. selecting circuitry) 770.

The detector is configured to detect presence of a second TDD system as described above.

The acquirer is configured to acquire the second configuration of time resources for downlink and uplink used by the second TDD system by detection of wireless control signaling from the second TDD system as described above.

The monitor is configured to monitor at least the received signal strength metric of the second TDD system, and possibly also a received signal quality metric of the first TDD system and/or a received signal quality metric of the second TDD system, as described above.

The selector is configured to select, based on the acquired second configuration and on the monitored received signal strength metric of the second TDD system, an interference mitigation algorithm from a set of applicable interference mitigation algorithms as described above.

The interference mitigator is configured to apply the selected interference mitigation algorithm to the received signals of the first TDD system (received by the transceiver) to reduce the interference caused by the second TDD system.

According to some embodiments, the principles of NAICS are, thus, extended to situations where no neighboring cell information is provided from the serving network node, e.g. when an interferer is controlled by another operator than the serving network node.

A method is proposed according to some embodiments, for detection by the UE of coexisting TDD cells at neighboring frequencies. Thereby, DL interference mitigation may be adapted accordingly. When the UE reads the information of the broadcast channel on the neighboring cell, this information can be used to efficiently reduce the interference from neighboring cells in a similar way as in a NAICS receiver.

In an example of what has been described above, when a UE is registered at an LTE TDD system, it will check whether there is a coexisting TDD system at a neighboring frequency within the TDD frequency band. This information may be detected by the UE as exemplified above.

For example, the UE may initiate an RSSI scan at neighboring frequencies at DRX (discontinuous reception) mode. FIG. 2 provides an example of the RSSI scan of neighboring frequencies where 200 denotes the allocated bandwidth of the UE and 201 and 202 are frequency ranges for RSSI scan. If the scan is to be performed in two frequency ranges 201 and 202, they may be equally wide or have different widths, but they should typically be limited to the TDD frequency band.

After the UE has completed the RSSI scan in this example, it will choose the maximum RSSI among all the measured samples and compare it to a threshold as described above. If the maximum RSSI is higher than the threshold, it is assumed that there is another LTE TDD cell at a neighboring frequency, and the UE will trigger an initial cell search at the frequency corresponding to the maximum RSSI. Otherwise UE will repeat RSSI scan regularly at DRX period to monitor whether there is an LTE TDD cell at a neighboring frequency or not.

When, in the initial cell search, the UE finds a physical cell identification (pci), the UE will trigger BCH (broadcast channel) reading to find the UL/DL configuration, which includes reading of master information block (MIB) and system information block Type 1 (SIB1).

All procedures may be scheduled at DRX mode, and when the UE detects a neighboring TDD cell's UL/DL configuration, it will record this information for interference mitigation.

If a coexisting TDD system is detected, the UE will keep track of each DL sub-frame's SINR (and/or RSRQ) for the wanted signal and RSSI for the interfering signal. Depending on SINR (and/or RSRQ) and RSSI and on the neighboring cell's UL/DL configuration, the UE will choose different interference mitigation algorithms as described above.

Information that may be beneficial to read from the wireless control signaling from the second TDD system and use in the selection and application of interference mitigation algorithm include, but is not limited to, cell information of the coexisting TDD system such as physical cell identification (pci), number of CRS ports, MBSFN configuration, and used transmission modes.

Some embodiments may provide for improved DL performance and robustness when the UE is suffering UE-to-UE and/or BS-to-UE interference from other operators when there is a coexisted TDD system at neighbor frequency. Some embodiments may be especially advantageous at static or slow moving scenarios.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device.

Embodiments may appear within an electronic apparatus (such as a wireless communication device) comprising arrangements, circuitry, and/or logic according to any of the embodiments described herein. Alternatively or additionally, an electronic apparatus (such as a wireless communication device) may be configured to perform methods according to any of the embodiments described herein.

According to some embodiments, a computer program product comprises a computer readable medium such as, for example a universal serial bus (USB) memory, a plug-in card, an embedded drive or a read only memory (ROM). FIG. 8 illustrates an example computer readable medium in the form of a compact disc (CD) ROM 800. The computer readable medium has stored thereon a computer program comprising program instructions. The computer program is loadable into a data processor (PROC) 820, which may, for example, be comprised in a wireless communication device 810. When loaded into the data processing unit, the computer program may be stored in a memory (MEM) 830 associated with or comprised in the data-processing unit. According to some embodiments, the computer program may, when loaded into and run by the data processing unit, cause execution of method steps according to, for example, any of the methods illustrated in FIGS. 3-6.

Reference has been made herein to various embodiments. However, a person skilled in the art would recognize numerous variations to the described embodiments that would still fall within the scope of the claims. For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Hence, it should be understood that the details of the described embodiments are merely examples brought forward for illustrative purposes, and that all variations that fall within the scope of the claims are intended to be embraced therein.

1.-24. (canceled)

25. A method for controlling interference mitigation for received signals of a wireless communication device operating in a first system, using a first frequency interval, the first system being provided by a first wireless communication system operator, the method comprising:
detecting a presence of a second system using a second frequency interval, wherein:
the first and second frequency intervals are overlapping or neighboring frequency intervals, and
the second system is provided by a second wireless communication system operator different from the first wireless communication system operator;
monitoring a received signal strength metric of the second system; and
selecting, based on the monitored received signal strength metric, an interference mitigation algorithm from a set comprising a first interference mitigation algorithm and a second interference mitigation algorithm, wherein:
the first interference mitigation algorithm is a successive interference cancellation algorithm, and
the second interference mitigation algorithm is an interference rejection algorithm.

26. The method of claim 25 wherein the first and second frequency intervals are neighboring frequency intervals, and wherein detecting the presence of the second system comprises:
performing a received signal strength metric scan over one or more third frequency intervals that include the second frequency interval; and
determining a maximum received signal strength metric of the scan.

27. The method of claim 26 further comprising:
comparing the maximum signal strength metric of the scan to a maximum interference threshold value; and
when it is determined that the maximum received signal strength metric is above the maximum interference threshold value, attempting operation in a wireless communication system other than the first system.

28. The method of claim 26 wherein detecting the presence of the second system further comprises:
comparing the maximum received signal strength metric of the scan to a detection threshold value; and
when it is determined that the maximum received signal strength metric is above the detection threshold value, performing cell search based on a candidate frequency associated with the maximum received signal strength metric and considering the presence of the second system detected when the cell search is successful.

29. The method of claim 28 wherein the detection threshold value is based on a received signal strength metric of the first system.

30. The method of claim 25, wherein:
the first system is a first time division duplex (TDD) system using a first configuration of time resources for downlink and uplink;
the second system is a second TDD system;
the method further comprises acquiring, by detecting wireless control signaling from the second TDD system, a second configuration of time resources for downlink and uplink used by the second TDD system; and
selecting the interference mitigation algorithm is further based on the acquired second configuration.

31. The method of claim 30 wherein acquiring the second configuration comprises reading system information received from the second TDD system.

32. The method of claim 25, wherein:
the method further comprises monitoring a received signal quality metric of the first system; and
selecting interference mitigation algorithm comprises:
comparing the monitored signal strength metric of the second system to a selection interference threshold value;
comparing the monitored received signal quality metric of the first system to a selection quality threshold value;
when it is determined that the monitored signal strength metric of the second system is above the selection interference threshold value and the monitored received signal quality metric of the first system is below the selection quality threshold value, selecting the first interference mitigation algorithm for the received signals of the first system; and
when it is determined that the monitored signal strength metric of the second system is above the selection interference threshold value and the monitored received signal quality metric of the first system is below the selection quality threshold value, selecting the second interference mitigation algorithm for the received signals of the first system.

33. The method of claim 25, wherein:
the method further comprises monitoring a received signal quality metric of the second system; and
selecting the interference mitigation algorithm is further based on the monitored received signal quality metric of the second system.

34. The method of claim 25, further comprising applying the selected interference mitigation algorithm to the received signals of the first system to reduce the interference caused by the second system.

35. A non-transitory, computer-readable medium storing program instructions that, when executed by a process of a wireless communication device, configure the wireless communication device to perform operations corresponding to the method of claim 25.

36. An arrangement for controlling interference mitigation for received signals of a wireless communication device operating in a first system using a first frequency interval, the first system being provided by a first wireless communication system operator, the arrangement comprising a controller configured to cause:
detection of a presence of a second system using a second frequency interval, wherein:
the first and second frequency intervals are overlapping or neighboring frequency intervals, and
the second system is provided by a second wireless communication system operator different from the first wireless communication system operator;
monitoring of a received signal strength metric of the second system; and
selection, based on the monitored received signal strength metric, of an interference mitigation algorithm from a set comprising a first interference mitigation algorithm and a second interference mitigation algorithm, wherein:
the first interference mitigation algorithm is a successive interference cancellation algorithm, and
the second interference mitigation algorithm is an interference rejection algorithm.

37. The arrangement of claim 36 wherein the first and second frequency intervals are neighboring frequency intervals, and wherein the controller is configured to cause detection of the presence of the second system by causing:
performance of a received signal strength metric scan over one or more third frequency intervals comprising the second frequency interval; and
determination of a maximum received signal strength metric of the scan.

38. The arrangement of claim 37, wherein the controller is further configured to cause:
comparison of the maximum signal strength metric of the scan to a maximum interference threshold value; and
responsive to a determination that the maximum received signal strength metric is above the maximum interference threshold value, an attempt to operate in a wireless communication system other than the first system.

39. The arrangement of claim 37, wherein the controller is further configured to cause the detection of the presence of the second system by causing:
comparison of the maximum received signal strength metric of the scan to a detection threshold value; and
responsive to a determination that the maximum received signal strength metric is above the detection threshold value, performance of cell search based on a candidate frequency associated with the maximum received signal strength metric of the scan and consideration that the presence of the second system is detected when the cell search is successful.

40. The arrangement of claim 39, wherein the detection threshold value is based on a received signal strength metric of the first system.

41. The arrangement of claim 36, wherein:
the first system is a first time division duplex (TDD) system using a first configuration of time resources for downlink and uplink;
the second system is a second TDD system;
the controller further configured to cause acquisition, by detecting wireless control signaling from the second TDD system, of a second configuration of time resources for downlink and uplink used by the second TDD system; and
the controller further configured to cause selection of the interference mitigation algorithm further based on the acquired second configuration.

42. The arrangement of claim 41, wherein the controller is configured to cause the acquisition of the second configuration by reading of system information received from the second TDD system.

43. The arrangement of claim 36, wherein:
the controller is further configured to cause monitoring of a received signal quality metric of the first system; and
the controller is configured to cause the selection of the interference mitigation algorithm by causing:
comparison of the monitored signal strength metric of the second system to a selection interference threshold value;
comparison of the monitored received signal quality metric of the first system to a selection quality threshold value;
when it is determined that the monitored signal strength metric of the second system is above the selection interference threshold value and the monitored received signal quality metric of the first system is below the selection quality threshold value, selection of the first interference mitigation algorithm for the received signals of the first system; and
when it is determined that the monitored signal strength metric of the second system is above the selection interference threshold value and the monitored received signal quality metric of the first system is below the selection quality threshold value, selection of the second interference mitigation algorithm for the received signals of the first system.

44. The arrangement of claim 36, wherein:
the controller is further configured to cause monitoring of a received signal quality metric of the second system; and
the selection of the interference mitigation algorithm is further based on the monitored received signal quality metric of the second system.

45. The arrangement of claim 36, wherein the controller is further configured to cause application of the selected interference mitigation algorithm to the received signals of the first system to reduce the interference caused by the second system.

46. A wireless communication device comprising the arrangement of claim 37.
